(19) United States
(12) Patent Application Publication
(10) Pub. No.: US 2015/0070919 A1
(43) Pub. Date: Mar. 12, 2015

(54) BICYCLE LIGHTING SYSTEM

(71) Applicants: Anthony Richard Howe, Barton Upon Humber (GB); Sean Anthony Howe, Barton Upon Humber (GB)

(72) Inventors: Anthony Richard Howe, Barton Upon Humber (GB); Sean Anthony Howe, Barton Upon Humber (GB)

(21) Appl. No.: 14/024,884

(22) Filed: Sep. 12, 2013

(51) Int. Cl. B62J 6/00

(52) U.S. Cl. CPC B62J 6/001; B62J 6/003; B62J 2006/008
USPC 362/476

(57) ABSTRACT

A bicycle lighting system comprises a front light 13 with a power source 11 with a cradle 12 for mounting on a bicycle, said front light 13 being releasably secured to the cradle 12 to allow removal of the front light 13 when the bicycle is not being used, front light indicator lights 14A, 14B powered by the from light power source, a rear light 23 with a power source 2 for mounting on a bicycle, rear indicator lights 24A. 24B powered by the rear light power source, and a switch device 30 for mounting, on the handlebars X to operate the lights, the switch device being adapted to control the rear light and rear indicator lights through a wireless connection. Removal of the front light from its cradle may disable the rear light. The system may also include a helmet-mounted wirelessly controlled light and the power sources may be kept charged by means of a solar panel.

The invention relates to a bicycle lighting system.

According to the present invention there is provided a bicycle lighting system comprising:

a) A front light with a power source with a mourning means for mounting on a bicycle, said front light being releasably secured to the mounting means to remove the from light when the bicycle is not being used,

b) front indicator tights powered by the front light power source,

c) a rear light with a power source for mounting on a bicycle,

d) rear indicator lights powered by the rear light power source,

e) and a switch device for mounting on the handlebars to operate the tights, said switch device being adapted to control the rear light and rear indicator lights through a wireless connection.

Preferably the front light and front light indicators are hard wired to the switch device.

Preferably the front indicator lights are part of a front light housing.

Preferably the rear indicator lights are part of the rear light housing.

Preferably the bicycle light system further includes a brake light. The brake light may be powered by the rear light power source.

The front light power source and rear light power source may include a solar panel.

The bicycle light system may further comprise one or more helmet lights for mounting on a bicycle helmet, and the or each light may be controlled by the switch device.

The rear light may have a mounting means for mounting on a bicycle, said rear light being releasably secured to the mounting means to remove the rear light when the bicycle is not being used.

Preferably removal of the front light from the mounting means disables operation of the rear lights.

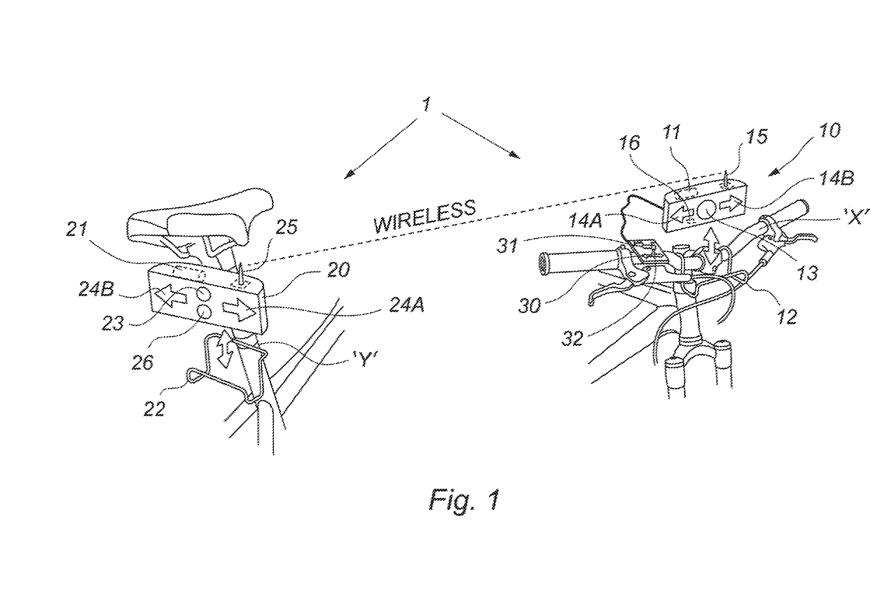

FIG. 1 illustrates one embodiment of the bicycle lighting system of the present invention shown in a perspective view in two portions mounted in a front (with handlebars) and rear (with seat post) part of a bicycle.

An embodiment of the invention will now be described with reference to the accompanying drawing showing a schematic perspective view. Referring to the drawing there is shown a bicycle lighting system

A front light housing 10 is provided with a power source in the form of a battery 11. Housing 10 is releasably secured to a mounting means such as a cradle 12 for mounting on a bicycle handlebar X, whereby the housing can be removed when the bicycle is not being used to prevent it being stolen. Housing 10 has a central front white light 13 powered by battery 11. Housing 10 also has front orange indicator lights 14A,14B (e.g. with arrow diffusers as shown) powered by the battery 11. A wireless circuit 15 is provided to communicate with rear tight housing 20 described below.

A rear light housing 20 is provided with a power source in the form of a battery 21. Housing 20 is releasably secured to a mounting means in the form of a cradle 22 for mounting on a bicycle seat post Y, whereby the housing can be removed when the bicycle is not being used to prevent it being stolen. Housing 20 has a central rear red light 23 powered by battery 11. Housing 20 also has front orange indicator lights 24A,24B (e.g. with arrow diffusers as shown) powered by the battery 21. A wireless circuit 25 is provided to communicate with front light housing wireless circuit 15. A rear red brake light 26 is provided powered by battery 21. Brake light 26 operates only when a bicycle is decelerating, e.g using a gravity/mercury type switch.

A switch device 30 is provided for mounting on the handlebars X to operate the lights. Switch device 30 has a first “On/Off” switch 31 which turns the front and rear light H and 23 on and off. Switch device 30 also has a left and right indicator switch 32 to control the front and rear left indicator lights 14A,24A and the front and rear right indicator lights 14B,24B.

Switch device 30 on handle bar X is wired to front housing 10 to control the front lights i3,14A,14B, but is adapted to control the rear light 23 and rear indicator lights 24A,24B through the wireless connection provided by the wireless circuits 15,25.

A switch 16 in the housing 10 operated by placing the housing 10 in cradle 11, ensures the rear lights cannot operate when the front housing is removed from cradle 11, whereby removal of the front light from the cradle disables operation of the rear lights.

The front light power source and rear light power source in the form of batteries 11,21 may include a solar panel (not shown).

The bicycle light system may further comprise one or more helmet lights for mounting on a bicycle helmet, and the or each light may be controlled by the switch device.

In use of a bicycle using the system of the invention, the rider is able to control the operation of the front and rear light and front and rear indicator lights using switch 31,32. The wireless connection between the front and rear housing 10,20 means that no wires between the two are required which can be damaged or make the bicycle unsightly. The front light can be removed so that it is not stolen when the bicycle to which it is fitted is left unattended. Once the front light is removed, the rear light is disabled operation of the rear lights so there is little temptation to steal the rear housing. The rear light may however be removed for security purposes.

The invention may take a form different to that specifically described above. For example the front or rear indicator lights could extend laterally from their housing or could he separate from their housing. If desired the rear light could be permanently fixed the bicycle rather than removable as shown. Also the front indicator lights 14A,14B could he separate to the front housing 10, e.g. mounted on the handlebars. The rear indicator light could be separate from the rear housing 20. The switch device 30 ma also he removable with housing. 10.

Further modifications will be apparent to those skilled in the art without departing from the scope of the present invention.

1. A bicycle lighting system comprising:
a) A front light with a power source with a mounting means for mounting on a bicycle, said front light being releasably secured to the mounting means to remove the front light when the bicycle is not being used,
b) front indicator lights powered by the front light power source,
c) a rear light with a power source for mounting on a bicycle,
d) rear indicator lights powered by the rear light power source,
e) and a switch device for mounting oil the handlebars to operate the lights, said switch device being adapted to control the rear light and rear indicator lights through a wireless connection.

2. A bicycle lighting system according to claim 1, wherein the front light and front light indicators are hard wired to the switch device.

3. A bicycle lighting, system according to claim 1, wherein the front indicator lights are part of a front light housing.

4. A bicycle lighting system according to claim 1, wherein the rear indicator lights are part of the rear light housing.

5. A bicycle lighting system according to claim 1, wherein the bicycle light system further includes a brake light.

6. A bicycle lighting system according to claim 5, wherein the brake light is powered by the rear light power source.

7. A bicycle lighting system according to claim 1, wherein the front light power source and rear light power source may include a solar panel.

8. A bicycle lighting system according to claim 1, wherein the bicycle light system further comprises one or more helmet lights for mounting on a bicycle helmet, and the or each light may be controlled by the switch device.

9. A bicycle lighting system according to claim 1, wherein the rear light has a mounting means for mourning on a bicycle, said rear light being releasably secured to the mounting means to remove the rear light when the bicycle is not being used.

10. A bicycle lighting system according to claim 1, whereby removal of the front light from the mounting means disables operation of the rear lights.

11. A bicycle lighting system according to claim 1, wherein removal of the front light from the cradle disables operation of the rear lights.
